(19) United States
(12) Patent Application Publication
(10) Pub. No.: US 2003/0097756 A1
(43) Pub. Date: May 29, 2003

(54) Device for cutting split ends used with electric hair clippers

(76) Inventors: Janette Klatt, Berka (DE); Peter Guss, Frankfurt (DE); Peter Scheunert, Dieburg (DE); Karl Trinkaus, Darmstadt (DE)

Correspondence Address: Striker Striker & Stenby, 103 East Neck Road, Huntington, NY, 11743, US

(21) Appl. No.: 10/332,415

(22) PCT Filed: Oct. 22, 2001
(86) PCT No.: PCT/EP01/12189

(30) Foreign Application Priority Data
Oct. 21, 2000 (DE) 200 18 049.5

(51) Int. Cl. B26B 19/48

(52) U.S. Cl. 30/134; 30/216

(57) ABSTRACT

A split end cutting device (20.2) is embodied as an attachment (15.2), which can be detachably connected to a hair cutting machine (21), where the attachment (15.2) has first and second deflecting sections (41, 42), which are disposed parallel to and spaced apart from each other by a distance (X). By means of a hinge (14.2), a third deflecting section (43) can be moved from a first position (A) passing between the first and second deflecting sections (41, 42) into a second position (B) parallel to the first and second deflecting sections (41, 42), in such a way that a lock of hair (28) placed underneath the first and second deflecting sections (41, 42) is engaged from underneath by the third deflecting section (43) and essentially constitutes an upside down U-shape. A cutting head (27) with the hair cutting machine (21) is positioned in a stationary fashion in such a way that when the lock of hair (28) is pulled through over the deflecting sections (41, 42, 43), only the protruding split ends (30) in an upper region (Y) of the third deflecting section (43) are cut off by the cutting head (27) (FIGS. 11 and 13).

The invention relates to a device for cutting split ends, which is used in service industries (hair salons) and in the private sector for cutting hair ends that are split (split ends).

It is known to twist hair with split ends into a lock in order to then remove the protruding split ends manually with scissors. Since only the split ends of the hair on the outside of the lock are cut in this case, this procedure must be repeated several times and therefore takes up a lot of time.

DE-OS 3422952 describes a split ends cutting device that permits damaged ends to be removed simply and quickly. In this case, the cutting device has a handle connected to a rod-shaped supporting part, whose circumferential surface has sets of parallel comb teeth extending over at least part of its length and at least one knife blade disposed between a pair of comb teeth sets, which the knife blade transfers. In its simplest embodiment, two rows of comb teeth are formed onto the supporting part of the cutting device, between which a fixed knife blade is situated. The knife blade is serrated, which is intended to assure a clean cutting of the hair ends. In another embodiment of the cutting device, which is particularly suited to electrical operation, the supporting part is comprised of a hollow body, whose wall has a slot between the rows of comb teeth. The knife blade is guided through the slot in the supporting part wall and is connected to a mount that is supported coaxial to the supporting part axis. An electric motor or vibrating magnetic drive mechanism is disposed in the handle as a drive mechanism for the blade mount and causes the mount to oscillate back and forth rapidly. It should be possible to use the above-described cutting device effectively for cutting split ends by guiding it several times with the knife blade side of the supporting part over the surface of a lock of hair, thereby cutting the tips caught by the comb teeth.

Because of its structural design, the end-cutting device described in this prior art is only partially suitable for removing split ends from the healthy hair. The placement of the knife blade directly against the lock of hair causes not only the split ends, but also the entire hair to be cut.

In addition, trouble-free hair cutting with a blade is only possible when the hair is wet, but then it is impossible to detect the split ends. By contrast, the dry knife cutting that must be used is unpleasant and painful. Since only thin locks of hair can be cut with this method and it is necessary to change the blade more frequently, the use of this hair end cutting device is very time and cost intensive.

The object of the invention is to produce a reasonably priced split end cutting device by means of which hair ends that are split (split ends) can be simply and conveniently removed from the healthy hair and which is very quick and inexpensive to use.

This object is achieved with the features disclosed in claim 1.

According to a first exemplary embodiment, the invention achieves the fact that with the opened split end cutting device, the lock of hair to be treated is engaged from underneath by the hair lock support. During the opening and closing process, the guide rollers, which are pressed toward each other by spring force, are spread against the hair lock support and are moved across it. The enclosed lock of hair is fixed on the circumference of the hair lock support and is held tightly underneath the hair lock support by the guide rolls resting against each other.

The split ends protruding from the circular cylindrical hair lock support are removed with an even cut by an electric hair cutting machine, which is spaced apart from the lock of hair and is disposed on the guide attachment.

The invention will be explained in detail in conjunction with three exemplary embodiments.

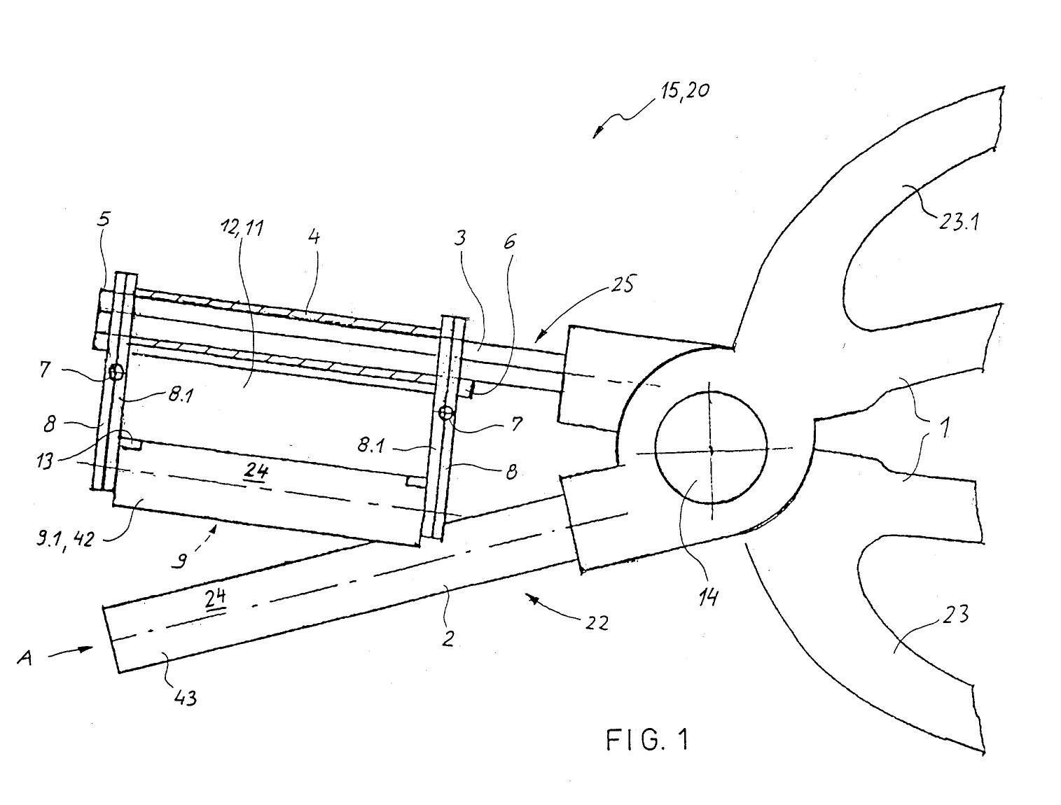

FIG. 1 shows a side view of an open split end cutting device according to a first exemplary embodiment;

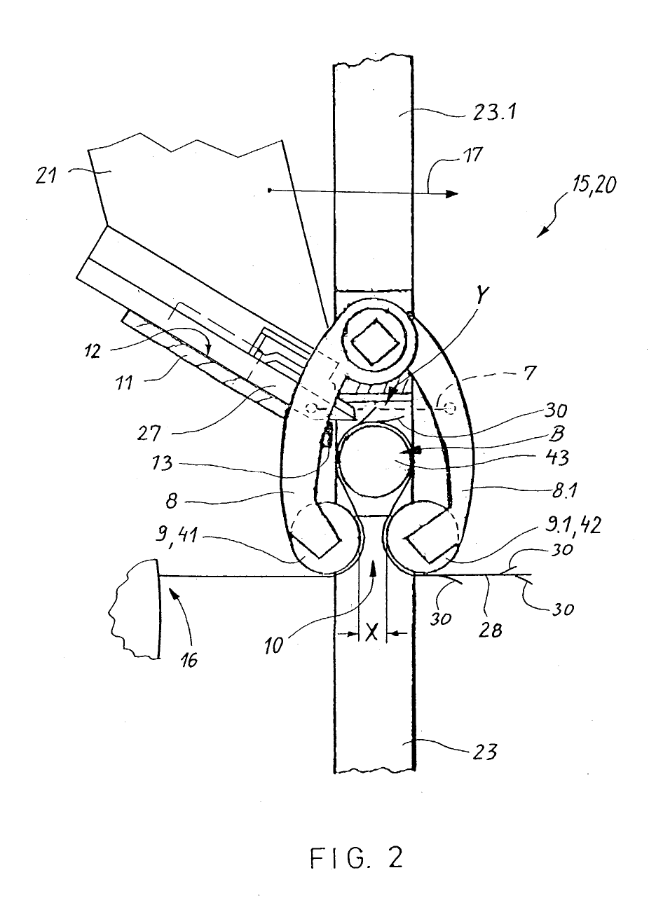

FIG. 2 shows a front view of the split end cutting device according to FIG. 1 with an enclosed lock of hair during a split end cutting procedure;

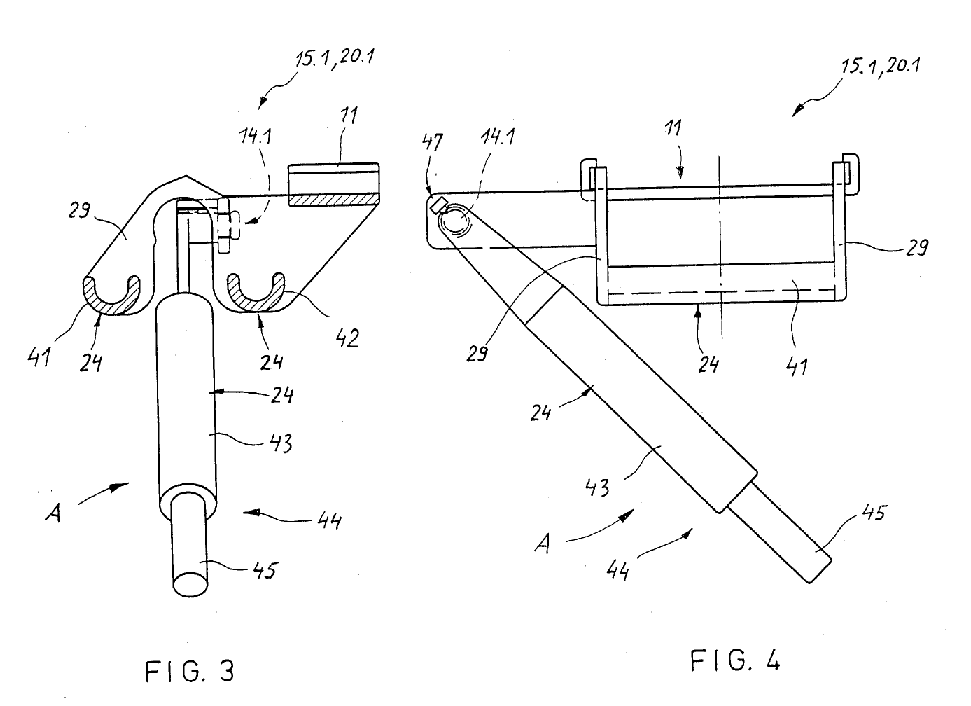

FIGS. 3 to 8 show different views of a second exemplary embodiment, and

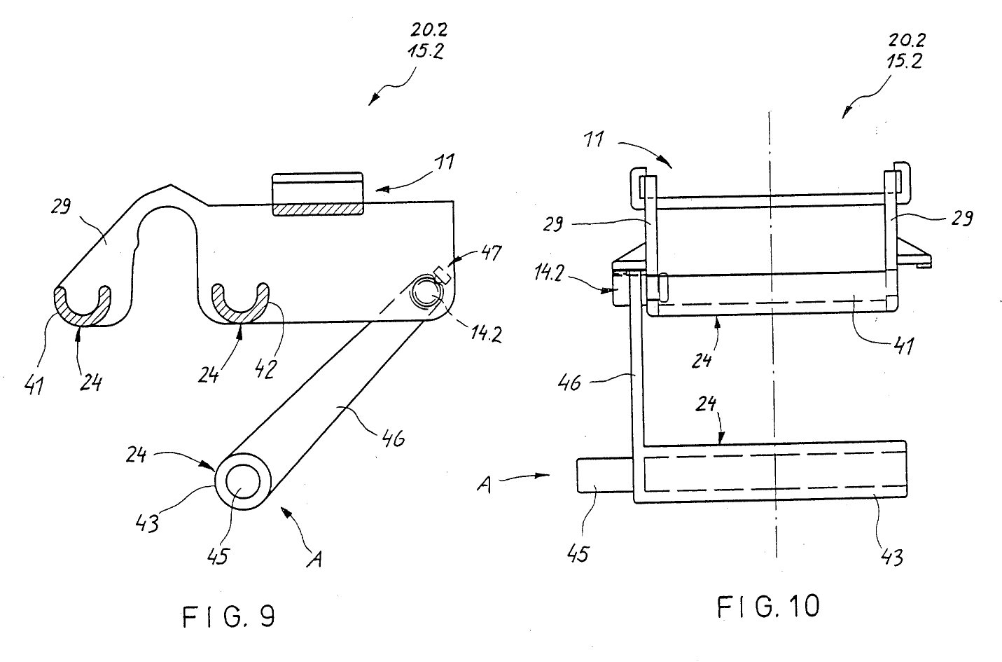

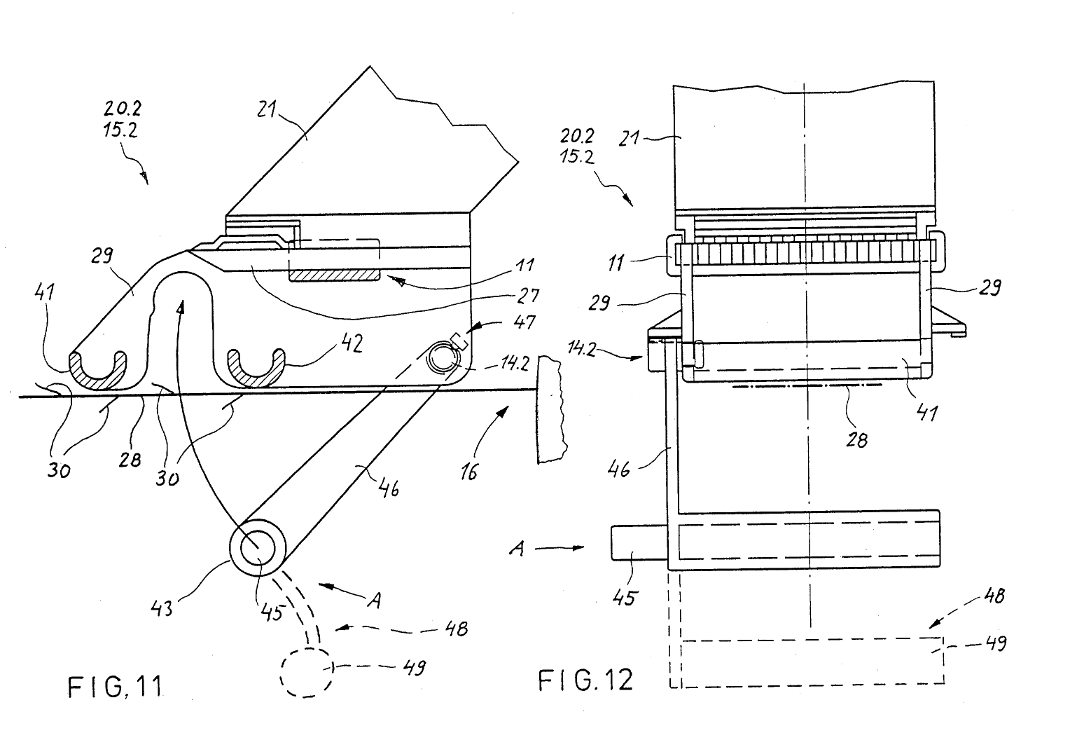

FIGS. 9 to 14 show different views of a third exemplary embodiment.

FIG. 1 shows a first exemplary embodiment of the split end cutting device 20 for an electric hair cutting machine 21 in which the split end cutting device 20 is embodied as an attachment 15 that can be detachably connected to a hair cutting machine 21. The attachment 15 has a first and second deflecting section 41, 42, which are disposed parallel to and spaced apart from each other by a distance X. By means of a hinge 14, a third deflecting section 43 can be moved from a first position A, passing between the first and second deflecting sections 41, 42 into a second position B parallel to the first and second deflecting sections 41, 42, in such a way that a lock of hair 28 placed underneath the first and second deflecting sections 41, 42 is engaged from underneath by the third deflecting section 43 and essentially constitutes an upside down U-shape, where a cutting head 27 with the hair cutting machine 21 is positioned in a stationary fashion in such a way that when the lock of hair 28 is pulled through over the deflecting sections 41, 42, 43, only the protruding split ends 30 in an upper region Y of the third deflecting section 43 are cut off by the cutting head 27. For the sake of a very favorable operation, the split end cutting device 20 is provided with a left- and/or right-handed pair of scissors handles 1 with a shared hinge 14. A lower scissors leg 22 of a hand-actuated handle part 23 is embodied as a circular cylindrical hair lock support 2 with a very smooth and slippery surface 24. Parallel to this hair lock support 2, another upper scissors leg 25 of the hand-actuated handle part 23 has a functional mount 3 that is triangular or rectangular to prevent axial rotation. The hair lock support 2 and the functional mount 3 here can be inserted into the handle parts 23, 23.1, but can also be manufactured of one piece with the handle parts 23, 23.1 using an injection molding process. A circular cylindrical functional support 4, which has a suitable triangular or rectangular inner receptacle 26 for the functional mount 3, has bearing pins 5 at its ends. It can be slid onto the functional mount 3 at both ends and is fastened to it in a rotationally secured fashion by means of known fastening means, e.g. clips. Two jaws 8, which are reflexively symmetrical to each other, are slid onto the bearing pins 5 of the functional support 4 and are secured in their position in relation to each other from the inside. Spring elements 7, which are embodied as compression springs above the bearing pins 5 or are embodied as tension springs below the bearing pins 5, move the jaws 8 toward each other until they are spaced apart by the distance X. The reflexively symmetrical jaws 8 are connected to each other by means of stationary or rotating guide rollers 9. Between the most distantly spaced jaws 8 of the opposed pairs of jaws, there is a seat 11 for detachably mounting a cutting head 27 of an electric hair cutting machine 21. The seat 11 is embodied after the fashion of an intrinsically known hair-thinning comb, which can be slid onto a hair cutting machine 21. The functional support 4, the jaws 8 that can be moved toward each other by the spring elements 7, the guide rollers 9, and the seat 11 in combination constitute an interchangeable structural component, which when slid onto the functional mount 3 and cooperating with the hair lock support 2, permits a neat removal of the split ends 30. When the split end cutting device 20 is open, the hair lock support 2 engages the lock of hair 28, which is to be cut, from underneath and the centering protrusions 6, which are formed onto the functional support 4, thereby center the pairs of jaws and the guide rollers 9 in relation to the hair lock support 2. During the closing of the split end cutting device 20, the hair lock support 2 pulls the lock of hair 28 between the automatically opening guide rollers 9. When the split end cutting device 20 is closed, as shown in FIG. 2, the guide rollers 9 that rest snugly against each other hold the hair tightly against the circumference of the hair lock support 2. In this connection, the internal hollows of the jaws 8 allow them to encompass the hair lock support 2 without touching it and consequently assure that the guide rollers 9 rest snugly against each other. When the lock of hair 28, starting from the base of the hair 16, is pulled through with the split end cutting device 20 closed, the circumferential grooves of the guide rollers 9 allow for a uniform hair lock width and consequently an optimal cutting of the split ends 30. In this connection, the collar-like, raised ends of the guide rollers 9, which are inserted into the jaws 8, prevent individual hairs from catching. The split ends 30, which the hair lock support 2 causes to stick out, are removed with a straight cut in the direction of the arrow 17 by an electric hair cutting machine 21, which is detachably fitted onto the seat 11 and is aligned at an angle of for example 15 to 45 degrees in relation to the symmetry axis of the hair lock support 2, pointing toward the parallel guide rollers 9. A cutting blade limiter 13, which spaces the electric hair cutting machine 21 apart from the hair lock support 2, prevents healthy hair from being cut. This procedure can be rapidly repeated with no trouble since only the split ends 30 are removed. The user of this split end cutting device 20 can decided based on his experience whether to use stationary guide rollers 9 or rotating guide rollers 9, depending on the type of hair. The ability of the functional support 4 to be slid onto the functional mount 3 at both ends also assures that this split end cutting device 20 can be used by both right-handed and left-handed users.

FIGS. 3 to 8 show a second exemplary embodiment of a split end cutting device 20.1 for an electric hair cutting machine 21 in which the split end cutting device 20.1 is embodied as an attachment 15.1, which can be detachably connected to a hair cutting machine 21. The attachment 15.1 has a first and a second deflecting section 41, 42, which are disposed parallel to and spaced apart from each other by a distance X. The distance X is considerably greater than the diameter of the third deflecting section 43 so that the lock of hair 28 can slide unhindered against the first and second deflecting sections 41, 42. The first and second deflecting sections 41, 42 are connected to two side wills 29 of the attachment 15.1. By means of a hinge 14.1, a third deflecting section 43 can be moved from a first position A, passing between the first and second deflecting sections 41, 42 into a second position B parallel to the first and second deflecting sections 41, 42, in such a way that a lock of hair 28 placed underneath the first and second deflecting sections 41, 42 is engaged from underneath by the third deflecting section 43 and essentially constitutes an upside down U-shape, where a cutting head 27 with the hair cutting machine 21 is positioned in a stationary fashion in such a way that when the lock of hair 28, starting from the base of the hair 16, is pulled through in the direction of arrow 17 over the deflecting sections 41, 42, 43, only the protruding split ends 30 in an upper region Y of the third deflecting section 43 are cut off by the cutting head 27. The first and second deflecting sections 41, 42 are affixed to the attachment 15.1; on one side of the attachment 15.1, the third deflecting section 43 is connected at one end to a hinge 14.1. A free end 44 of the third deflecting section 43 is provided with a guide handle 45 for moving the deflecting section 43 from a first position A into a second position B and vice versa. The first, second, and third deflecting sections 41, 42, 43 are provided with a U-shaped cross section, which means that they can be provided in the form of an inexpensive injection-molded part. The third deflecting section 43 can be embodied so that it can be connected to the attachment 15.1 on the left and/or right side, which permits it to be used with either the left or right hand. The first, second, and third deflecting sections 41, 42, 43 are provided with a smooth surface 24 and can be alternatively provided in the form of a stationary or axially rotatable roller 9. In principle, merely a smooth surface 24 suffices in order to achieve a low friction between the deflecting sections 41, 42, 43 and the lock of hair 28. Except for the third deflecting section 43, the attachment 15.1 is embodied of one piece made of plastic. In order to facilitate its operation, the third deflecting section 43 is provided with a detent mechanism 47 for position A and for position B. For the detachable connection of the split end cutting device 20.1 to the hair cutting machine 21, the attachment 15.1 is provided with a seat 11 for the cutting head 27. The seat 11 is embodied after the fashion of an intrinsically known hair thinning comb, which can be slid onto a hair cutting machine 21. As shown with dashed lines, the third deflecting section 43 is provided with a hair lock pressing device 48, which corresponds at least to the first or second deflecting section 41, 42, which additionally generates a slight tension on the lock of hair 28 being pulled through in order to deliberately cause the split ends 30 to protrude outward in the upper region Y of the third deflecting section 43. Advantageously, the hair lock pressing device 48 is provided with a brush 49 for pressing against the lock of hair 28.

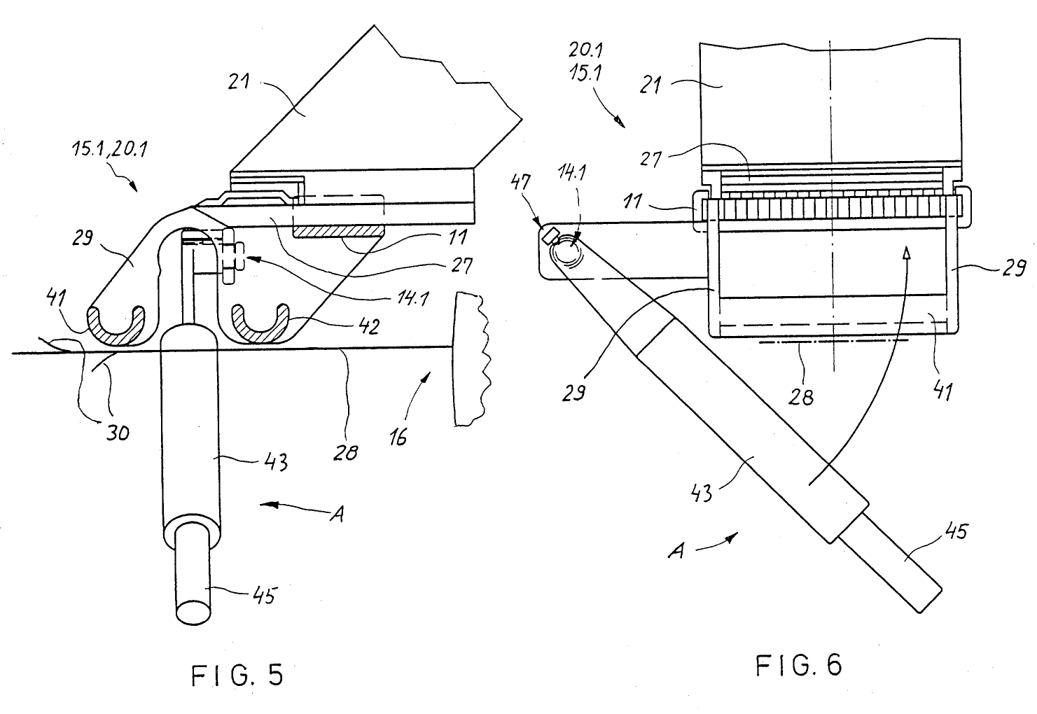

FIGS. 3 and 4 show different views of the attachment 15.1 in a position A, without a hair cutting machine 21; by contrast, FIGS. 5 and 6 show the attachment from FIGS. 3 and 4 in a position A, with a hair cutting machine 21 and with a lock of hair 28 placed onto the third deflecting section 43.

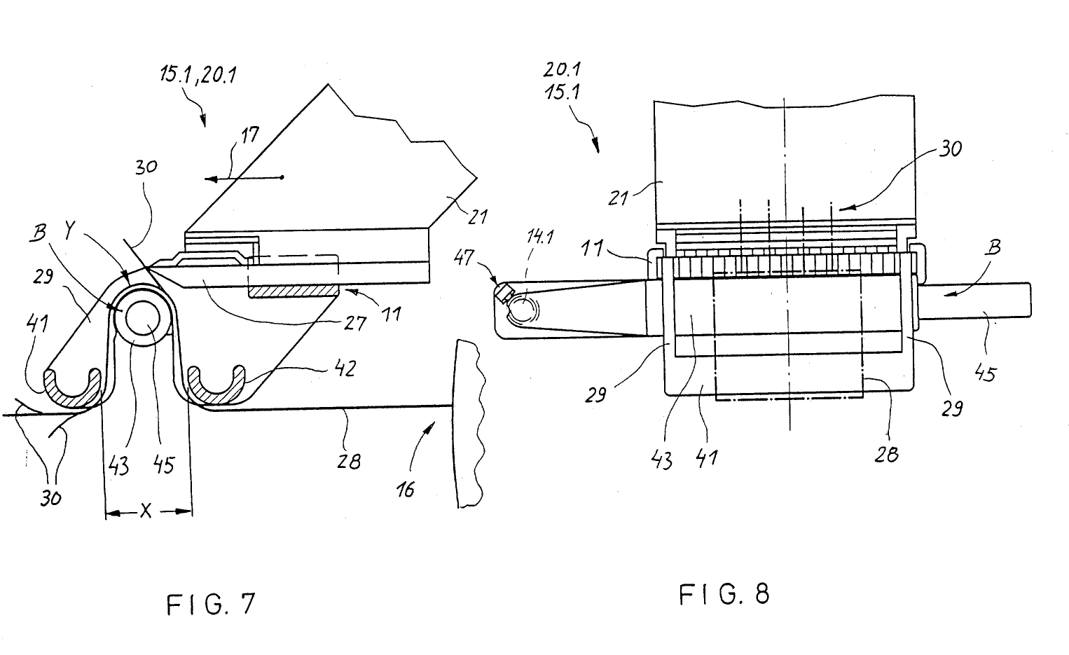

FIGS. 7 and 8 show different views of the attachment 15.1 in a position B, with the hair cutting machine 21, clarifying the position and function of the cutting head 27 for cutting off the protruding split ends 28. The seat 11 for the hair cutting machine 21 is embodied in such a way that the cutting head 27 is provided with a detent seating so that its position is fixed.

FIGS. 9 to 14 show a third exemplary embodiment of a split end cutting device 20.2 for an electric hair cutting machine 21, where the split end cutting device 20.2 is embodied as an attachment 15.2 that can be detachably connected to a hair cutting machine 21. The attachment 15.2 has a first and a second deflecting section 41, 42, which are disposed parallel to and spaced apart from each other by a distance X. The distance X is considerably greater than the diameter of the third deflecting section 43 so that the lock of hair 28 can slide unhindered against the first and second deflecting sections 41, 42. The first and second deflecting sections 41, 42 are connected to two side wills 29 of the attachment 15.1. By means of a hinge 14.2, a third deflecting section 43 can be moved from a first position A, passing between the first and second deflecting sections 41, 42 into a second position B parallel to the first and second deflecting sections 41, 42, in such a way that a lock of hair 28 placed underneath the first and second deflecting sections 41, 42 is engaged from underneath by the third deflecting section 43 and essentially constitutes an upside down U-shape, where a cutting head 27 with the hair cutting machine 21 is positioned in a stationary fashion in such a way that when the lock of hair 28, starting from the base of the hair 16, is pulled through in the direction of arrow 17 over the deflecting sections 41, 42, 43, only the protruding split ends 30 in an upper region Y of the third deflecting section 43 are cut off by the cutting head 27. The first and second deflecting sections 41, 42 are affixed to the attachment 15.2; the third deflecting section 43 is connected at one end to a pivoting lever 46, which is pivotably connected with a hinge 14.2 to the attachment 15.2 in order to move the deflecting section 43 from a first position A into a second position B and vice versa. The pivoting lever 46 achieves the fact that all of the deflecting sections 41, 42, 43 are always oriented parallel to one another, independent of the angular position of the pivoting lever 46 between position A and B, which reliably prevents an undesired slippage of a lock of hair 28 on the third deflecting section 43 from position A toward position B. In addition, this achieves a very compact design of the attachment 15.2. The first, second, and third deflecting sections 41, 42, 43 are provided with a U-shaped cross section, which means that they can be provided in the form of an inexpensive injection-molded part. The third deflecting section 43 can be embodied so that it can be connected to the attachment 15.2 on the left and/or right side, which means that the split end cutting device 20.2 can be used by both right-handed and left-handed people. The first, second, and third deflecting sections 41, 42, 43 are provided with a smooth surface 24 and can be alternatively provided in the form of a stationary or axially rotatable roller 9. Except for the third deflecting section 43, the attachment 15.2 is embodied of one piece made of plastic. In order to facilitate its operation, the third deflecting section 43 is provided with a detent mechanism 47 for position A and for position B. For the detachable connection of the split end cutting device 20.2 to the hair cutting machine 21, the attachment 15.2 is provided with a seat 11 for the cutting head 27. The seat 11 is embodied after the fashion of an intrinsically known hair thinning comb, which can be slid onto a hair cutting machine 21. The third deflecting section 43 is provided with a hair lock pressing device 48, which corresponds at least to the first or second deflecting section 41, 42, which additionally generates a slight tension on the lock of hair 28 being pulled through in order to deliberately cause the split ends 30 to protrude outward in the upper region Y of the third deflecting section 43. Advantageously, the hair lock pressing device 48 is provided with a brush 49 for pressing against the lock of hair 28.

FIGS. 9 and 10 show different views of the attachment 15.2 in a position A, without a hair cutting machine 21; by contrast, FIGS. 1 1 and 12 show the attachment from FIGS. 9 and 10 in a position A, with a hair cutting machine 21 and with a lock of hair 28 placed onto the third deflecting section 43.

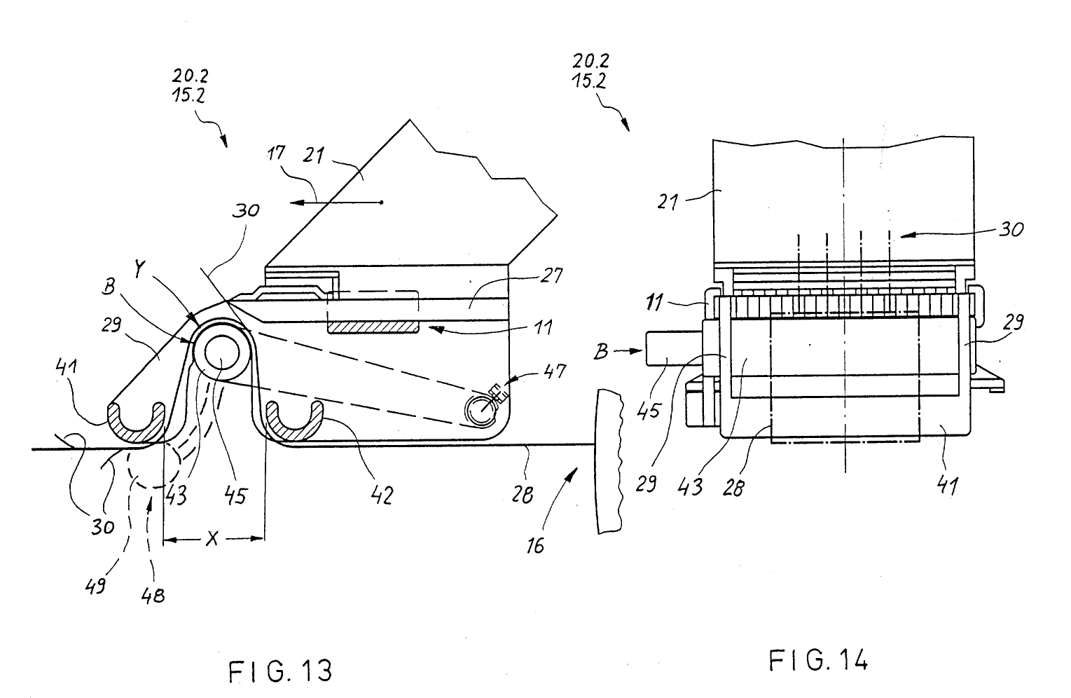

FIGS. 13 and 14 show different views of the attachment 15.2 in a position B, with the hair cutting machine 21, clarifying the position and function of the cutting head 27 for cutting off the protruding split ends 28. The seat 11 for the hair cutting machine 21 is embodied in such a way that the cutting head 27 is provided with a detent seating so that its position is fixed.

### REFERENCE NUMERAL LIST

1 pair of scissors handles

2 hair lock support

3 functional mount

4 functional support

5 bearing pin

6 centering protrusion

7 spring element

8, 8.1 jaws

9, 9.1 guide roller

10 hair lock guide channel

11 seat

12 scissor head support surface

13 cutting blade limiter

14, 14.1, 14.2 hinge

15, 15.1, 15.2 attachment

16 base of hair

17 arrow

20, 20.1, 20.2 split end cutting device

21 hair cutting machine

22 lower scissors leg

23, 23.1 handle part

24 surface

25 upper scissors leg

26 internal hollow

27 cutting head

28 lock of hair

29 side wall

30 split ends

41 first deflecting section

42 second deflecting section

43 third deflecting section

44 free end

45 guide handle

46 pivoting lever

47 detent mechanism

48 hair lock pressing device

49 brush

A first position

B second position

X distance

Y upper region

1. A split end cutting device, characterized in that
the split end cutting device (20, 20.1, 20.2) is embodied as an attachment (15, 15.1, 15.2), that can be detachably connected to a hair cutting machine (21), that
the attachment (15, 15.1, 15.2) has a first and second deflecting section (41, 42), which are disposed parallel to and spaced apart from each other by a distance (X), that
by means of a hinge (14, 14.1, 14.2), a third deflecting section (43) can be moved from a first position (A) passing between the first and second deflecting sections (41, 42) into a second position (B) parallel to the first and second deflecting sections (41, 42), in such a way that a lock of hair (28) placed underneath the first and second deflecting sections (41, 42) is engaged from underneath by the third deflecting section (43) and essentially constitutes an upside down U-shape, where
a cutting head (27) with the hair cutting machine (21) is positioned in a stationary fashion in such a way that when the lock of hair (28) is pulled through over the deflecting sections (41, 42, 43), only the protruding split ends (30) in an upper region (Y) of the third deflecting section (43) are cut off by the cutting head (27).

2. The split end cutting device according to claim 1, characterized in that
the third deflecting section (43) is provided with a hinge (14) of a pair of scissors handles (1), where
the split end cutting device (20) has a left- and/or right-handed pair of scissors handles (1), that
a scissors leg (22) of a thumb-actuated handle part (23) is embodied as a circular cylindrical hair lock support (2) with a smooth and slippery surface (24), that
parallel to this hair lock support (2), a scissors leg side (25) of the finger-actuated handle part (23) has a triangular or rectangular functional mount (3), that
the hair lock support (2) and the functional mount (3) here can be inserted into the handle parts (23) or can be manufactured of one piece with the handle parts (23) using an injection molding process, that
a circular cylindrical functional support (4), which has a suitable triangular or rectangular inner receptacle (26) for the functional mount (3), has bearing pins (5) at its ends, that
the functional support (4) can be slid onto the functional mount (3) at both ends and is fastened to it in a rotationally secured fashion by means of intrinsically known fastening means, that
two jaws (8), which are reflexively symmetrical to each other, are slid onto the bearing pins (5) of the functional support (4) and are secured in their position in relation to each other by these pins, that
spring elements (7), which are embodied as compression springs above the bearing pins (5) or are embodied as tension springs below the bearing pins (5), move the jaws (8) toward each other, that
the reflexively symmetrical jaws (8) are connected to each other by means of stationary or rotating guide rollers (9), that
between the most distantly spaced jaws (8) of the opposed pairs of jaws, there is a seat (11) for detachably mounting a cutting head (27) of the electric hair cutting machine (21), that
the functional support (4), the jaws (8) that are moved toward each other by the spring elements (7), the guide rollers (9), and the guide attachment (11) in combination constitute an interchangeable structural component, which when slid onto the functional mount (3), cooperates with the hair lock support (2), that
when the split end cutting device (20) is open, the hair lock support (2) engages the lock of hair (28), which is to be cut, from underneath and the centering protrusions (6), which are formed onto the functional support (4), thereby center the pairs of jaws and the guide rollers (9) in relation to the hair lock support (2), that
during the closing of the split end cutting device (20), the hair lock support (2) pulls the lock of hair (28) between the automatically opening guide rollers (9), where when the split end cutting device (20) is closed, the guide rollers (9) that rest snugly against each other hold the lock of hair (28) tightly against the circumference of the hair lock support (2), where
internal hollows (29) of the jaws (8) allow them to encompass the hair lock support (2) without touching it and consequently assure that the guide rollers (9) rest snugly against each other, where
as the lock of hair (28) is pulled through when the split end cutting device (20) closed, the circumferential grooves of the guide rollers (9) allow for a uniform hair lock width and consequently an optimal cutting of the split ends (30), where
the collar-like, raised ends of the guide rollers (9), which are inserted into the jaws (8), prevent individual hairs from catching, where
the split ends (30), which the hair lock support (2) causes to stick out, can be removed with a straight cut by an electric hair cutting machine (20), which is fitted onto the seat (11) and is aligned at an angle of for example 15 to 45 degrees in relation to the symmetry axis of the hair lock support (2), pointing toward the parallel guide rollers (9), and that
a cutting blade limiter (13), which spaces the electric hair cutting machine (20) apart from the hair lock support (2), prevents healthy hair from being cut.

3. The split end cutting device according to claim 1, characterized in that the first and second deflecting sections (41, 42) are affixed to the attachment (15.1), where on one side of the attachment (15.1), the third deflecting section (43) is connected at one end to a hinge (14.1) and that a free end (44) of the third deflecting section (43) is provided with a guide handle (45) for moving the deflecting section (43) from a first position (A) into a second position (B) and vice versa.

4. The split end cutting device according to claim 1, characterized in that the first and second deflecting sections (41, 42) are affixed to the attachment (15.2), where the third deflecting section (43) is connected at one end to a pivoting lever (46), which is pivotably connected with a hinge (14.2) to the attachment (15.2) in order to move the deflecting section (43) from a first position (A) into a second position (B) and vice versa.

5. The split end cutting device according to claim 3 or 4, characterized in that the first, second and third deflecting sections (41, 42, 43) are provided with a U-shaped cross section.

6. The split end cutting device according to claim 3 or 4, characterized in that the third deflecting section (43) is embodied so that it can be connected to the attachment (15.1, 15.2) on the right and/or left side.

7. The split end cutting device according to claim 3 or 4, characterized in that the first, second and third deflecting sections (41, 42, 43) are each provided with a smooth surface (24).

8. The split end cutting device according to claim 3 or 4, characterized in that the first, second and third deflecting sections (41, 42, 43) are provided in the form of a roller (9) that is either stationary or can be axially rotated.

9. The split end cutting device according to claim 3 or 4, characterized in that except for the third deflecting section (43), the attachment (15.1, 15.2) is embodied in one piece made of plastic.

10. The split end cutting device according to claim 3 or 4, characterized in that the third deflecting section (43) is provided with a detent mechanism (47) for position (A) and for position (B).

11. The split end cutting device according to claim 3 or 4, characterized in that the attachment (15.1, 15.2) is provided with a seat (11) for detachably mounting the cutting head (27).

12. The split end cutting device according to at least claim 1, characterized in that the third deflecting section (43) is provided with a hair lock pressing device (48), which corresponds to at least the first or second deflecting section (41, 42).

13. The split end cutting device according to at least claim 1, characterized in that the hair lock pressing device (48) is provided with a brush (49).
